(19) United States
(12) Patent Application Publication
(10) Pub. No.: US 2026/0112814 A1
(43) Pub. Date: Apr. 23, 2026

(54) ANTENNA DESIGN USING DEEP LEARNING

(71) Applicant: City University of Hong Kong, Kowloon (HK)

(72) Inventors: Kwok Wa Leung, Kowloon (HK); Qiheng Huang, Kowloon (HK)

(21) Appl. No.: 18/924,079

(22) Filed: Oct. 23, 2024

(51) Int. Cl. H01Q 9/04

(52) U.S. Cl. CPC H01Q 9/0485

(57) ABSTRACT

There is provided a computer-implemented method of training a heterogeneous graph convolution network (Het-GCN) for antenna design, which includes modeling an antenna as graph data, the graph data including heterogeneous graphs representing different components of the antenna, generating radiation pattern and reflection coefficient of the antenna for a dataset based on the graph data, and training the Het-GCN using the dataset. A computer-implemented method of designing a cylindrical dielectric resonator antenna (DRA) using the Het-GCN as trained by the aforementioned method is also provided.

### TECHNICAL FIELD

The present invention relates to methods and systems for antenna design using deep learning. In particular, the present invention provides methods and systems of training a heterogeneous graph convolution network (Het-GCN) for antenna design, and methods and systems of designing an antenna using the Het-GCN.

### BACKGROUND

As an important component in wireless communication systems, antennas have been widely investigated to fulfill different challenging requirements. Sometimes simple antenna structures are not able to meet the specifications, and unconventional antenna structures that have many sensitive parameters may be needed. Direct simulations of unconventional antenna structures can be very time-consuming, especially when they rely on the trial-and-error approach by human experience. Therefore, it is imperative to develop new methods to solve the problem.

### SUMMARY OF THE INVENTION

Exemplary embodiments of the invention apply deep learning to design or synthesize a directional dielectric resonator antenna. Some embodiments of the invention explore a bi-branch heterogeneous graph convolution network (Het-GCN) to assist complex and computationally demanding antenna designs. The model can directly generate radiation pattern and reflection coefficient of a given antenna structure, with each prediction completed in milliseconds. The antenna configuration is modeled as a graph and optimized using gradient descent. Some embodiments of the invention make use of the Het-GCN to synthesize four cylindrical dielectric resonator antennas with different distributions of dielectric constants. These antennas successfully provide the desired main-beam directions at 0°, 30°, 60°, and 90°. Comparisons with existing machine learning methods show that the method according to some embodiments can increase design flexibility and accuracy.

According to a first aspect of the invention, there is provided a computer-implemented method of training a heterogeneous graph convolution network (Het-GCN) for antenna design, which includes modeling an antenna as graph data, the graph data comprising heterogeneous graphs representing different components of the antenna, generating radiation pattern and reflection coefficient of the antenna for a dataset based on the graph data, and training the Het-GCN using the dataset.

In some embodiments, the antenna may include a cylindrical dielectric resonator antenna (DRA). The cylindrical DRA may include a ground plane, a dielectric resonator element operably coupled with the ground plane, and a feeding probe operably coupled with the dielectric resonator element.

In some embodiments, the ground plane may include an Aluminium ground. In some embodiments, the dielectric resonator element may include a first number (N) of layers of different dielectric constants arranged from the feeding probe, and be angularly divided into a second number (M) of sections such that the dielectric resonator element consists of N×M dielectric resonator blocks.

In some embodiments, the cylindrical DRA may be centrally fed by the feeding probe with a height of hₚ.

In some embodiments, antenna characteristics of the cylindrical DRA may be adjusted by manipulating dielectric constant distribution within the dielectric resonator blocks, the height (hₚ) of the feeding probe, and a width (w_{d}) of a layer of the dielectric resonator element.

In some embodiments, modeling the antenna as graph data may further include randomly generating antenna parameters, the antenna parameters comprising dielectric constant distribution, a height (hₚ) of the feeding probe, and a width (w_{d}) of a layer of the dielectric resonator element.

In some embodiments, the graph data may include node attributes for the components of the cylindrical DRA where each component serves as a node, and edge attributes for interactions between nodes.

In some embodiments, the components of the cylindrical DRA may include the dielectric resonator blocks and the feeding probe.

In some embodiments, the node attributes may be constructed based geometric parameters and material property of the components of the cylindrical DRA.

In some embodiments, the interactions between nodes may include propagations of electromagnetic wave between adjacent nodes.

In some embodiments, the Het-GCN may be designed to perform convolution function on the graph data.

In some embodiments, in the Het-GCN, different types of relations are assigned by specified convolution functions, and weights are not shared among the different types of relations.

In some embodiments, in the Het-GCN, a readout function is operated on all node features in a convoluted graph to obtain a graph-level representation (GLR).

In some embodiments, the Het-GCN may be structured with two separate branches of multi-layer perceptions (MLPs) operated on the graph-level representation for predicting the radiation pattern and the reflection coefficient respectively.

According to a second aspect of the invention, there is provided a computer-implemented method of designing a cylindrical dielectric resonator antenna (DRA) using the Het-GCN as trained by the method of the first aspect, which includes obtaining a desired antenna structure of the cylindrical DRA with a specific radiating direction using the trained Het-GCN.

In some embodiments, obtaining the desired antenna structure may include providing radiation pattern and reflection coefficient of a reference antenna structure to the trained Het-GCN, initializing randomly in the neighborhood of the reference antenna structure, and iteratively obtaining an optimal antenna structure using mini-batch gradient descent.

In some embodiments, iteratively obtaining the optimal antenna structure may include adjusting dielectric constant distribution within the dielectric resonator blocks for controlling radiation pattern variation and the height of the feeding probe for impedance matching.

In some embodiments, iteratively obtaining the optimal antenna structure may further include adjusting the width of the layer of the dielectric resonator element.

In some embodiments, the specific radiating direction may be one of four different elevation angles, 0°, 30°, 60° and 90°.

According to a third aspect of the invention, there is provided a system for training a heterogeneous graph convolution network (Het-GCN) for antenna design, which includes one or more processors, and memory storing one or more programs configured to be executed by the one or more processors, the one or more programs including instructions for performing or facilitating performing of the method of the first aspect.

According to a fourth aspect of the invention, there is provided a system for designing a cylindrical dielectric resonator antenna (DRA) using a heterogeneous graph convolution network (Het-GCN), which includes one or more processor, and memory storing one or more programs configured to be executed by the one or more processors, the one or more programs including instructions for performing or facilitating performing of the method of the second aspect.

According to a fifth aspect of the invention, there is provided a non-transitory computer-readable storage medium storing one or more programs configured to be executed by one or more processors, the one or more programs including instructions for performing or facilitating performing of the method of the first aspect or the method of the second aspect.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

FIG. 1 shows configuration of a cylindrical dielectric resonator antenna according to an embodiment of the invention (top and sectional views).

FIG. 2 shows antenna graph modeling according to an embodiment of the invention.

FIG. 3 shows a structure of a heterogeneous graph convolution network (Het-GCN) model according to an embodiment of the invention.

FIG. 4 shows a flowchart of a design method according to an embodiment of the invention.

FIG. 5A shows comparison among models of NMSE value on different sizes of datasets, and FIG. 5B shows comparison among models of correlation value on different sizes of datasets.

FIG. 6 shows an example of mini-batch gradient descent with k batch size. There are k particles {pᵢ₁, pᵢ₂, . . . , pᵢₖ} updated at each iteration i.

FIG. 7 shows radiation pattern optimization cost function calculation.

FIG. 8 shows the number of iterations in four optimizing processes.

FIGS. 9A to 9D show the reflection coefficient of the design variable hₚ for 0 deg, 30 deg, 60 deg, and 90 deg respectively.

FIG. 10 shows an example unit cell used in 3D printing for obtaining an effective dielectric.

FIGS. 11A-11D show optimized results of dielectric constant distributions of the 4 antennas at four different elevation angles, 0°, 30°, 60°, and 90°; FIGS. 11E-11H show optimized results of equivalent 3D-printing model structures of the 4 antennas at four different elevation angles, 0°, 30°, 60°, and 90°; FIGS. 11I-11L show optimized results of reflection coefficients of the 4 antennas at four different elevation angles, 0°, 30°, 60°, and 90°; FIGS. 11M-11P show optimized results of radiation patterns at ø=0° plane at 5.8 GHz from both simulation and Het-GCN prediction of the 4 antennas at four different elevation angles, 0°, 30°, 60°, and 90°.

FIG. 12 shows an example 3D-printing model of 30-deg antenna.

FIGS. 13A and 13B show example diagrams of top view and perspective view of fabricated 30-deg antenna; and FIGS. 13C and 13D show example diagrams of top view and perspective view of 60-deg antenna.

FIGS. 14A and 14B show measurement results of reflection coefficient (S₁₁) of the fabricated 30-deg antenna and 60-deg antenna, respectively; FIGS. 14C and 14D show measurement results of radiation pattern of the x-z plane at 5.8 GHz of the fabricated 30-deg antenna and 60-deg antenna, respectively; FIGS. 14E and 14F show measurement results of realized gain at the maximum radiating direction of the fabricated 30-deg antenna and 60-deg antenna, respectively; FIGS. 14G and 14H show measurement results of efficiency of the fabricated 30-deg antenna and 60-deg antenna, respectively.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Artificial intelligence (AI) has a significant impact on an engineering sector as it continues to advance. In addition to traditional neural networks, graph neural network (GNN) is also a powerful AI method. A graph is a data structure that can describe non-Euclidean data. Structural design problems usually contain both Euclidean and non-Euclidean data. Therefore, the GNN has become a valuable assistant for engineers to find a better solution efficiently. In this disclosure, a bi-branch heterogeneous graph convolution network (Het-GCN or HGCN) is introduced to handle complicated and computational antenna designs. The model can directly output radiation pattern and reflection coefficient of a given antenna structure. Each prediction is finished in milliseconds. And optimization can be accomplished by utilizing the differentiability of the neural network. By modeling the antenna configuration into a graph, the antenna is optimized through gradient descent. Four cylindrical dielectric resonator antennas with different dielectric constant distributions are synthesized based on the Het-GCN. The four antennas achieve desired radiation pattern performance at specific directions, 0°, 30°, 60° and 90°, respectively.

Hereinafter, some embodiments of the invention will be described in detail with reference to the drawings.

### Synthesis of Directional Cylindrical Dielectric Resonator Antenna Using Deep Learning

In recent years, artificial intelligence (AI) has received increasing attention in antenna designs. AI can handle complex problems with essential mathematical tools and parallel processing. It can alleviate the intensive weight of simulations, greatly facilitating antenna designs. Machine learning (ML), a branch of AI [6], is a promising solution to problems with high computational costs, and it has gotten much attention in the field of electromagnetics [1] [2]. Many typical ML algorithms have been developed for electromagnetic (EM) problems. For example, the population-based meta-heuristic optimization method, like the genetic algorithm [12]-[14], has been widely used in antenna optimizations in place of manual adjustments. It identifies a global optimum by evaluating previous offsprings and generating new superior search directions. However, it is computationally expensive and therefore time-consuming. To address this problem, the surrogate-assisted evolutionary algorithm (SAEA) optimization approach [15]-[17] has been explored as a compromise of the efficiency and accuracy. The SAEA combines a ML prediction model with an evolutionary algorithm to achieve optimizations, using a less accurate but efficient surrogate model to guide the optimization process. In contrast, Kriging and Radial Basis Function (RBF) can be trained to obtain more accurate models for inferring EM parameters directly. Also, it can improve the efficiency in handling nonlinear problems. Other widely adopted ML algorithms include Support Vector Machines (SVM) [3], Artificial Neural Networks (ANN) [5], and Autoencoders [4]. In recent years, these highly accurate models together with EM simulation have been deployed for antenna designs, enabling more efficient and reliable optimizations [18]-[21].

The training process of ML is quick, but it is unsuitable when the problem is complicated. To address this limitation, deep learning (DL) has later been developed to tackle complicated problems. It needs more datasets and training parameters to obtain a solution. Generative adversarial networks (GAN) [7], recurrent neural networks (RNN) [8], convolutional neural networks (CNN) [9], reinforcement learning [11], and transfer learning [10] are popular learning approaches of DL. Based on these DL algorithms, various approaches for antenna design have also been explored. For instance, a DL-FDTD method, incorporating RNN or CNN modules, is proposed as an enhanced version of the Finite Difference Time Domain (FDTD) technique to solve forward scattering problems effectively, such as electromagnetic computations and predictions of parameters [26]. In and [25], ANNs are extended deeper as multi-branch to solve multi-objective optimization problems. With the help of DL, the number of simulations in the complex optimization process can be significantly reduced to increase the efficiency. Sometimes, it is even unnecessary to do simulations. Once the AI model has learnt the relationship between the antenna geometric parameters and corresponding EM characteristics from the collected dataset, it can predict the antenna properties directly. Furthermore, it increases the likelihood of finding a superior solution because more trials can be conducted automatically.

Existing models may encounter limitations when dealing with non-Euclidean structural data, restricting their generalizability. Most existing methods treat the antenna data as either sequential data (time domain) or a set of Euclidean data (space domain). Whether it is sequential or Euclidean data depends on how researchers construct the database. However, some antenna parameters are independent of one another, and it may be somewhat arguable to handle them as sequential or Euclidean data. Take a rectangular patch antenna as an example. Its length and width are independent of each other and unrelated to time. But when they are grouped sequentially, it will undesirably and yet inevitably introduce a time relationship between them. The parameters of length and width are spatially independent of each other, but grouping them in the Euclidean data format will somehow introduce a spatial relationship between them. Although the existing methods can give accurate predictions, their solutions are kind of “black boxes” due to their limited interpretability. When the antenna configuration is slightly changed, e.g., a new component is added, the pre-trained model will no longer be valid, and a new training process will be needed.

The low interpretability and generalizability can be improved by introducing the graph neural network (GNN). Early investigations on GNN were inspired by the work of Sperduti and Starita [27], who applied neural networks to directed acyclic graphs. The concept of GNN was first systematically discussed in and further developed in [29], [30]. Later, the Convolutional Graph Neural Networks (ConvGNNs) extend the convolution operation from Euclidean data to non-Euclidean data. It utilizes multiple graph convolutional layers to extract high-level node and edge segmentations in a graph, enabling the construction of complex GNN models. The incorporation of the convolution operation into a graph neural network can improve the interpretability and modeling capability, facilitating the extraction of spatial characteristics in non-Euclidean data.

In complex structure designs, the heterogeneous graph convolutional network (Het-GCN) is an extension of the ConvGNN. Unlike ConvGNN that considers simpler homogeneous graphs, Het-GCN handles heterogeneous graphs consisting of various types of nodes in a single graph. They have been successfully applied to the molecular structure prediction and generation [33], [34], as well as the circuit distribution design [35]. One important advantage of these methods is their ability to incorporate prior knowledge into the input, allowing the neural network to learn more meaningful information through the message passing in a graph. Consequently, for structure optimization problems, the performance of Het-GCN theoretically surpasses that of traditional neural networks. Although the graph learning model is flexible in handling a physical structural problem, it has not been applied to antenna designs thus far. In this disclosure, the Het-GCN method is deployed to design an antenna.

The dielectric resonator antenna (DRA) proposed by S. A. Long et al. in 1983 [36] utilizes the resonance of electromagnetic waves in a dielectric constant medium to generate radiation. It has a number of advantages such as its small size, light weight, low loss, and ease of excitation. Since the DRA is a three-dimensional structure, it has higher design degrees of freedom as compared with wire and microstrip antennas. This provides increased design flexibility and adaptability to the specific requirements of diverse 5G communication system applications. Some embodiments of the invention will deploy the Het-GCN method to design a directional DRA. A directional DRA can be obtained by placing a monopole inside the DRA [13] [38]. In some embodiments, an alternative approach of modifying the dielectric constant distribution by means of ML is investigated to achieve the directionality.

An objective of some embodiments of the invention is to design or synthesize a cylindrical DRA that radiates at specific directions. In some embodiments of the invention, the DRA is divided into a number of unit blocks, and the objective is achieved by manipulating the dielectric constant distribution within the dielectric resonator blocks. The Het-GCN method can expedite the design process of this complicated structure that has a high complexity of the antenna parameters. A graph representation is constructed to serve as an input for the Het-GCN. An output of the Het-GCN model consists of two branches for predicting reflection coefficient and radiation pattern. It is found that by training the Het-GCN model with 3000 data samples, an excellent prediction performance on the validation set can be obtained with a low normalized mean square error of 0.06602 and high Pearson correlation coefficient of 0.95308. In this disclosure, the Het-GCN model will be compared with existing ML models to show its superiority. With the assistance of the Het-GCN, four directional antennas that radiate at different E-plane elevation angles of θ=0°, 30°, 60°, and 90° can be synthesized efficiently.

### I. Antenna Configuration

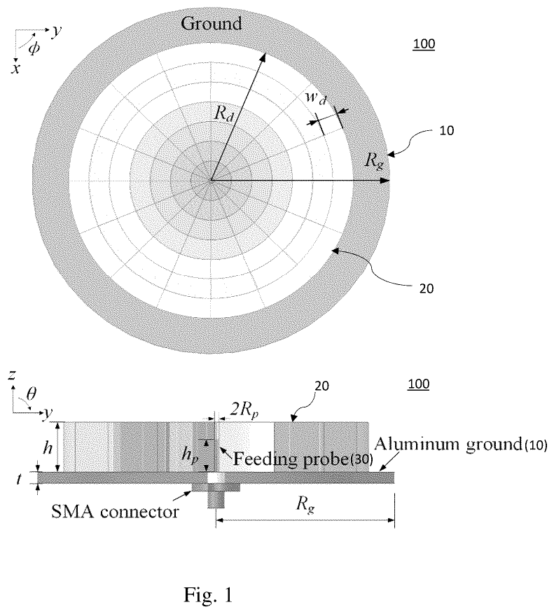

A directional antenna design according to some embodiments of the invention starts with a wideband, low-profile omnidirectional multi-ring cylindrical dielectric resonator antenna (DRA) [37]. FIG. 1 shows an initial configuration of a cylindrical DRA 100 according to an embodiment of the invention (top and sectional views). The cylindrical DRA 100 consists of a ground plane 10, a cylindrical dielectric resonator element 20 operably coupled with the ground plane 10, and a feeding prove 30 operably coupled with the dielectric resonator element 20. The ground plane 10 may be an aluminum ground, and the feeding prove 30 may be a central feeding coaxial probe. The dielectric resonator element 20 may include a first number (N) of layers of different dielectric constants arranged from the feeding probe 30, and is angularly divided into a second number (M) of sections such that the dielectric resonator element 20 consists of N×M dielectric resonator blocks. For example, the dielectric resonator element 20 has 7 layers of different dielectric constants, with a fixed height (h) of 9 mm. It is angularly divided into 16 sections. The antenna is centrally fed by the coaxial probe 30 with a height of hₚ. By changing the dielectric constant distribution, the probe height hₚ, and the width w_{d} (d=1, 2, . . . ,7), the antenna characteristics can be adjusted accordingly. In an example, the cylindrical DRA 100 has dimensions of h=9 mm, 2Rₚ=1.27 mm, R_{g}=44 mm, t=2 mm. hₚ∈[6.0 mm, 7.0 mm], w_{d}∈[0 mm, 5 mm] if d=1, 2, 3, and [5 mm, 15 mm] if d=4, 5, 6, 7.

### II. Design Method of Het-GCN

The antenna structure can be modeled as graph data. Antennas generally comprise different parts. They can be represented as heterogeneous graphs, and each component of the antenna can serve as a node in the graph. Therefore, a heterogeneous graph convolutional neural network can be constructed to learn from the antenna graph, and the propagation of electromagnetic wave between adjacent parts can be interpreted as interactions between the nodes.

In the model according to some embodiments of the invention, both geometric parameters and permittivity of each antenna part are simultaneously considered to increase the optimization flexibility. The Het-GCN learns the graph information and utilizes message-passing modules to extract the useful information from the graph.

### A. Antenna Graph Modeling

To feed the antenna data into the Het-GCN, each data sample is reconstructed as a graph representation. A graph is composed of two main elements: the vertices (or nodes) denoted as V and edges denoted as E. This can be represented as [symbol] =(V, E). The edges represent connections between nodes. Each node is represented by vᵢ∈V. An edge directing from vⱼ to vᵢ can be represented as eᵢⱼ=(vᵢ, vⱼ)∈E. If a node v has an edge (v, u), then u is considered as the neighbor of v, denoted as N(v). There may be node attributes X−R^{n×d} and edge attributes X^{e}∈R^{m×c} in a graph. The n, m are the numbers of nodes and edges, whereas d and c are the attribute dimensions of nodes and edges, respectively. The node feature vector of node v is represented as xᵥ∈R^{d}, and the edge feature vector of edge e=(v, u) is

$${x}_{v , u}^{e} ∈ {R}^{c} .$$

Based on the physical relationship between different antenna components, the antenna can be modeled as an undirected heterogeneous graph. It refers to a graph that contains different categories of nodes with undirected edges.

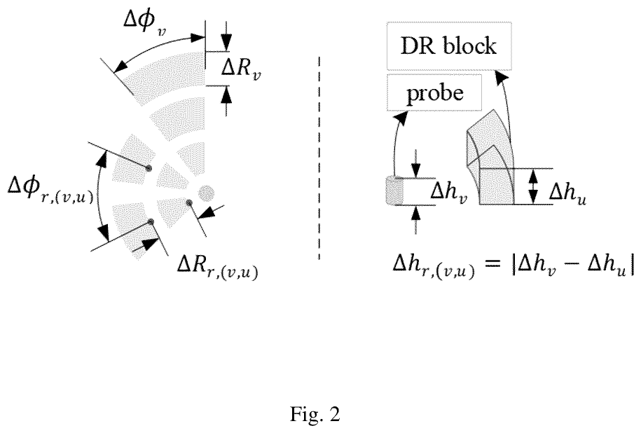

As shown in FIG. 2, the components of an antenna, such as the previously divided dielectric resonator blocks (DR blocks) and the coaxial probe, can be treated as individual nodes in the graph. The wᵥ, φᵥ, hᵥ and ε_{effv} refer to width, angle, height and dielectric constant of DR block of node v, respectively, which form the node attribute. The ΔRT_{r,(v,u)}, Δφ_{r,(v,u)} and Δh_{r,(v,u)} give relative position at three directions in the cylindrical coordinate system between two nodes v and u, which form the edge attribute. It is worth noting that the Aluminium ground is not included in the graph representation because it is fixed, i.e., it does not vary in the auto-design process. From the geometric parameters and material property of the antenna component, the attribute of node v xᵥ in the Het-GCN model can be constructed as follows:

$${x}_{v} = [ \frac{{w}_{v}}{max ( w )} , \frac{{ϕ}_{v}}{max ( ϕ )} , \frac{{h}_{v}}{max ( h )} , \frac{{ε}_{{eff}_{v}}}{max ( {ε}_{eff} )} ] , \qquad ( 1 )$$

where wᵥ, φᵥ hᵥ, and ε_{effv} refer to the width, angle, height, and effective permittivity of node v, respectively. The category of the node in the antenna graph can be the DR block or probe. The angle value of the node for the feeding probe is zero, whereas the effective permittivity ε_{eff} is set to 1.

Connections between the nodes in the graph representation of the antenna follow the physical structure, meaning that the edges exist between neighboring components only. The attribute of the edge between a pair of nodes v, u with relation r is defined as

$${x}_{r , ( v , u )}^{e} = [ Δ {w}_{r , ( v , u )} , {Δϕ}_{r , ( v , u )} , Δ {h}_{r , ( v , u )} ] .$$

In some embodiments of the invention, the DRA is divided into 7×16=112 DR blocks. Together with the probe, the graph representation has a total of 112+1=113 nodes. Obviously, there are two types of nodes (x_{v∈DR}, x_{v∈probe}) and two types of undirected edges (x_{r∈(DR,DR)}, x_{r∈(probe,DR)}) in the antenna graph. A set of node attributes X∈R^{113×4} and a set of edge attributes X^{e}∈R^{224×3} provide the graph information. This modeling approach is flexible for antenna designs because it allows for various geometries and properties. It also allows for both Euclidean and non-Euclidean connections.

### B. Het-GCN

Graph-level task. Predicting the EM characteristics of an antenna is a graph-level task. Let

$$𝒢 = {\{ {𝒢}^{p} \}}_{p = 1}^{N}$$

be a set of graphs, where | [symbol] |=N, the label of [symbol] ^{p} is defined as y^{p}. The objective of the graph-level task is to predict the property of an unseen graph, i.e., the EM response of an antenna graph.

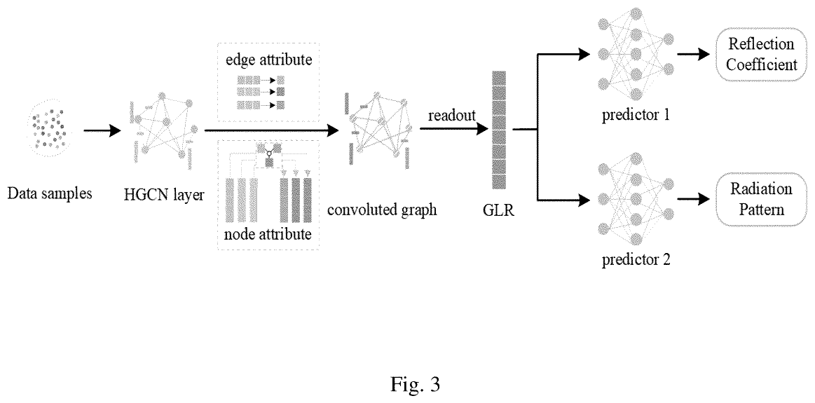

Het-GCN model. FIG. 3 shows the Het-GCN structure according to an embodiment of the invention (hereinafter, “proposed model”). Different from regular GCN, the Het-GCN can work on heterogeneous graph data. In the Het-GCN, different types of relations are assigned by specified convolution functions. Weights are not shared among different relations. The Het-GCN can handle different types of relations using specific convolution functions, such as the graph convolution [39] and SAGE convolution [40]. In the proposed model, the following graph convolution function is used for all types of relations:

$${h}_{i}^{( l + 1 )} = σ ( {W}_{0}^{( l )} {h}_{i}^{( l + 1 )} + {\sum }_{r ∈ ℛ} {\sum }_{j ∈ {𝒩}_{r} ( i )} \frac{{e}_{r , ji}}{{c}_{r , j i}} {W}_{r}^{( l )} {h}_{j}^{( l )} ) \qquad ( 3 )$$

$${c}_{r , ji} = \sqrt{\vert {𝒩}_{r} ( j ) \vert \sqrt{\vert {𝒩}_{r} ( i ) \vert}} \qquad ( 4 )$$

where σ(·) is an activation function, in which

$${h}_{i}^{( l )}$$

and W^{(l)} refer to the hidden state and weight matrix of layer l, respectively. In (3), the eⱼᵢ is the pre-defined weights of the edge from node j to i. It is normalized by c_{r,ji} that the [symbol] (i) with r∈ [symbol] is the node degree representing the number of neighbors of node i, and c_{r,ji} is used for the normalization of the neighboring-node contribution. The eⱼᵢ of all edges are set as 1 and the ReLU(·)=max (0, ·) is used as σ(·) in the proposed model. Overall, this equation describes the computation of the hidden state

$${h}_{i}^{( l )}$$

for node i at layer l in the Het-GCN model.

After the graphs are convoluted by equation (3), the attribute of each node is updated. To further obtain a graph-level representation (GLR), a readout function R(·) in equation (5) is operated on all the node features

$${h}_{i}^{T}$$

in the convoluted graph. This function combines the node features to summarize the entire graph. Following the readout function, two separate branches of multi-layer perceptions (MLPs) are used. Each branch has one hidden layer and operates on the same GLR. These MLP branches act as predictors for two tasks: one predicts radiation pattern RP, and the other predicts reflection coefficient S₁₁.

$$GLR = R ( {h}_{i}^{T} ∈ 𝒢 ) = {\sum }_{r ∈ ℛ} ( {\sum }_{j ∈ {𝒢}_{r}} {h}_{j}^{T} / \vert {𝒢}_{r} \vert ) \qquad ( 5 )$$

### C. Forward and Inverse Process for Antenna Design

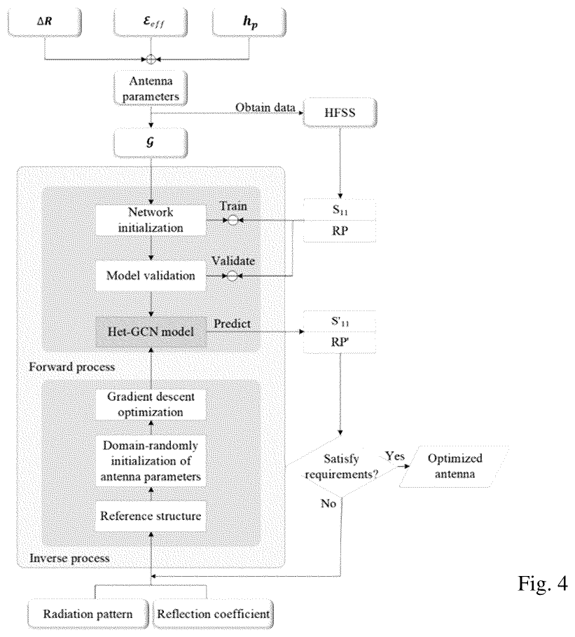

The flowchart of the design method according to an embodiment of the invention is depicted in FIG. 4. The antenna auto-design procedure consists of two parts: the forward problem and the inverse problem. In the forward problem, the goal is to obtain the EM characteristics of a given antenna structure. The inverse problem is to find a set of antenna configurations and numeric parameters that meet criteria. The antenna parameters are randomly generated in the forward process. Corresponding radiation pattern RP and reflection coefficient S₁₁ are first obtained using, for example, ANSYS HFSS. The above data forms the dataset D to train the Het-GCN with randomly initialized weights ωᵢ. The input of the model is the antenna graph [symbol] , which contains the information of dielectric constant ε_{effv} width of rings w_{d} (or relative radius ΔR) and height of probe hₚ of each node.

In the reverse process, a set of reference antenna parameters that are close to desired requirements is provided based on human experience. This reference antenna serves as a starting point of an optimization algorithm. After initializing randomly in the neighborhood of the reference antenna, an optimal antenna structure is iteratively discovered using mini-batch gradient descent.

### III. Dataset Construction and Model Training

### A. Data Collecting

Through numerous simulations conducted in ANSYS HFSS within a frequency band ranging from 3.5 GHz to 10.5 GHZ, dataset D can be created. Each simulation takes around 8 minutes. After antenna graph modeling, each sample in the dataset is denoted as Dᵢ=( [symbol] ᵢ; RPᵢ, S₁₁ᵢ), i=1, 2, . . . , N, where i represents the index of the sample and N is the size of dataset D. N equals to 3000 in an example in model training.

### B. Model Training and Evaluation

As introduced previously, the Het-GCN model takes the constructed antenna graph as input and produces outputs through two branches. For example, the RP branch generates a vector with a dimension of 1×74 at 5.8 GHz, consisting of 37 values for co-polarization and 37 values for cross-polarization in the x-z plane. The S₁₁ branch yields a total of 71 output values, with each value corresponding to a frequency point evenly distributed across the range of 3.5 GHz to 10.5 GHz. The model is trained under the guidance of the average loss from two branches. The loss of each branch is obtained through a loss function [symbol] , which is the normalized mean square error (NMSE) as formulated in equation (6). This loss function quantifies the discrepancy between the predicted values and the ground truth values, with normalization applied to ensure consistency across different scales. The performance of the Het-GCN is evaluated using an additional metric, Pearson correlation [symbol] as formulated in equation (7). The Pearson correlation measures the linear relationship between the predicted values and the actual values. It provides an indication of how well the model captures the patterns and trends in the data.

$$= {𝔼}_{( 𝒢 , y ) ∼ D} ( \frac{1}{{N}_{y}} \sum \frac{{( \hat{y} - y )}^{2}}{{y}^{2}} ) \qquad ( 6 )$$

$$𝒫 = \frac{{\sum }_{i} ( {\hat{y}}_{ι} - \overline{\hat{y}} ) ( {y}_{i} - \overline{y} )}{\sqrt{{\sum }_{i} {( {\hat{y}}_{ι} - \overline{\hat{y}} )}^{2} {\sum }_{i} {( {y}_{i} - \overline{y} )}^{2}}} \qquad ( 7 )$$

where y and ŷ refer to the ground truth and prediction result respectively.

The hyper-parameters of the Het-GCN model can be found in Table I. When training the model, the number of Het-GCN layers is set as 2 in order to strike a balance between computational complexity and accuracy. The maximum number of training iterations is set to 50 with a training batch size of 16.

TABLE I
THE PARAMETERS OF HET-GCN

| Input | 1* [symbol] | Output | Predictor1 | 1 × 71 |
|---|---|---|---|---|
| dimension | | dimension | Predictor2 | 1 × 74 |
| Number of | Forward | | | |
| HGCN layer | batch size | NMSE | Correlation | Memory |
| 1 | 16 | 0.06554 | 0.9513 | 1.07M |
| 2 | 8 | 0.06782 | 0.9455 | 1.25M |
| | 16 | 0.06602 | 0.9531 | 2.30M |
| | 32 | 0.06847 | 0.9521 | 4.40M |
| | 64 | 0.06893 | 0.94251 | 8.67M |
| | 128 | 0.07701 | 0.90439 | 17.15M |
| 3 | 16 | 0.07095 | 0.92794 | 10.82M |

3000 data samples are used to train the Het-GCN model, while the other 1000 remained for validation. The performance is compared with the other commonly used AI algorithms in Table II. The proposed Het-GCN method achieved the lowest NMSE of 0.06602, indicating superior performance. It also outperformed other approaches in terms of Pearson correlation with a value of 0.9508. However, it is worth noting that graph data requires more memory to accommodate additional information, such as node and edge features. The interactions among nodes also require more weights than traditional convolutional neural networks, resulting in a longer training time of 15862.29 seconds. Nevertheless, since the model only needs to be trained once for later usage, the training time of the Het-GCN model is considered acceptable.

TABLE II
MODEL PERFORMANCE ON VALIDATION SET

| | | | Training | |
|---|---|---|---|---|
| Model | NMSE | Correlation | time(s) | Memory |
| Adaboost | 0.11998 | 0.92643 | 1.7029 | 4.87M |
| Gaussian | 0.18095 | 0.86371 | 52.0151 | 0.76M |
| Process | | | | |
| Linear | 0.16309 | 0.89069 | 0.1821 | 0.067M |
| Regression | | | | |
| Decision | 0.19088 | 0.85242 | 4.4218 | 0.077M |
| Tree | | | | |
| SVR (RBF) | 0.15723 | 0.89021 | 115.00 | 0.60M |
| MLP | 0.11758 | 0.92979 | 12502.16 | 5.1M |
| CNN | 0.07602 | 0.92008 | 15727.93 | 1.18M |
| HGCN | 0.06602 | 0.95308 | 15862.29 | 2.3M |

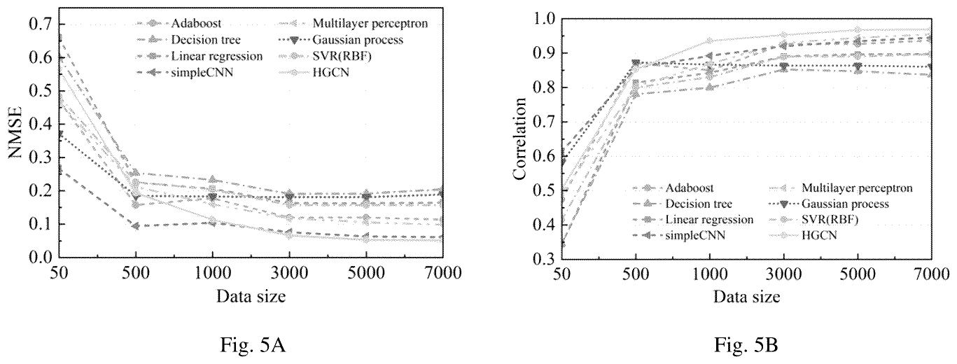

A comparison of the model performance across different data sizes is also given, as shown in FIGS. 5A and 5B. All the models are evaluated in the same validation set. The accuracy of the Het-GCN model improved as the dataset size increased. However, the improvement becomes less significant after the data size is larger than 3000. Compared to other algorithms, the Het-GCN requires a larger amount of data to train as it has more trainable parameters. With data size larger than 1000, the Het-GCN method consistently outperformed all other methods in terms of accuracy. In simpler terms, the Het-GCN model needs relatively more data to work effectively and give more reliable results.

### IV. Directional Radiation Cylindrical Dielectric Resonator Antenna Synthesis

### A. Optimization Process

During the optimization process, it aims to synthesize four antennas with specific radiating directions at four different elevation angles, 0°, 30°, 60°, and 90°. To realize this, adjusting the effective permittivity distribution ε_{eff} for controlling radiation pattern variation and the height hₚ for impedance matching is considered. The ε_{eff} has a significant impact on the corresponding EM behavior. Here, 7 discrete values are considered for the effective permittivity, ε_{eff}∈{1, 2.5, 4, 5.5, 7, 8.5, 10}. The hₚ can be varied within the range of 6.0 mm to 7.0 mm. And ΔR_{d} is initially fixed as 5 mm for all d. When the degree of freedom of ε_{eff} is insufficient to find a solution, adjusting the ΔR_{d} is also considered. Under the circumstance ΔR_{d} takes values within [0 mm, 5 mm] for d=1, 2, 3, and [5 mm, 15 mm] for d=4, 5, 6, 7.

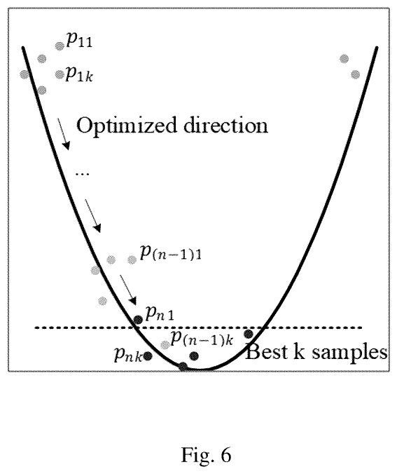

Using the well-trained Het-GCN model, the complicated antenna structure can be optimized. To accomplish this, mini-batch gradient descent is adopted. FIG. 6 shows an example working scheme of mini-batch gradient descent with a batch size of k. There are k samples being updated simultaneously at each iteration i. Subsequently, the best k samples are simulated for evaluation, and the optimal design is selected based on the simulation results. In this scenario, the value of k is set to 10.

The optimizing objective for the design is to make the antenna to radiate at specified directions, 0°, 30°, 60° and 90°, at 5.8 GHZ, while the return loss S₁₁<−10 dB. In other words, to synthesize antennas with a satisfactory performance at 5.8 GHz, the return loss Sn is required to be below −10 dB. The desired −10 dB band of S₁₁ should cover the frequency range of 5.4 GHz to 6.2 GHz. The L2 norm is applied to measure the difference between the ideal S₁₁ and the current S₁₁ during optimization. The RP is regulated by the expected main beam angle, back-lobe level, and cross-polar level. The cost function we aim to minimize during the optimization process is formulated as follows:

$$cost = {α}_{1} {cost}_{{S}_{11}} + {α}_{2} {cost}_{R P} \qquad ( 1 )$$

$$where$$

$${cost}_{{S}_{11}} = {‖ max ( 0 , {S}_{{11}_{i}}^{in - band} - ( - 10 ) ) ‖}_{2} \qquad ( 2 )$$

$${cost}_{R P} = \vert {α}_{θ} ( {\hat{θ}}_{0} - {θ}_{0} ) \vert + {‖ max ( 0 , {G}_{c o} ( θ , φ ) - {G}_{upper} ( θ , φ ) ) ‖}_{1} + {‖ max ( 0 , {G}_{lower} ( θ , φ ) - {G}_{c o} ( θ , φ ) ) ‖}_{1} + max ( 0 , 15 - min ( {G}_{c o} ( θ , φ ) - {G}_{c r} ( θ , φ ) ) ) \qquad ( 3 )$$

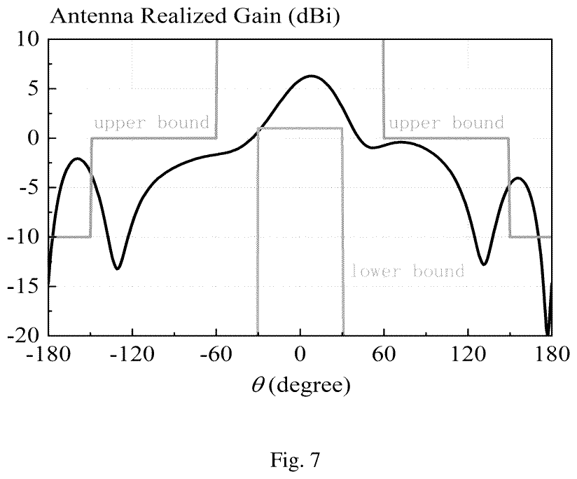

\hat{θ}₀ and θ₀ refer to the predicted and expected main beam elevation direction respectively. G_{co}(θ, φ) and G_{cr}(θ, φ) are the radiation patterns of co-polar and cross-polar. For the x-z plane, φ=0° and θ∈{−180°, 180°}. The upper bound Gᵤₚₚₑᵣ and the lower bound G_{lower} are visualized in FIG. 7. The borders define the acceptable range for the co-polarization. The co-polarization should fall within the upper and lower bounds. α₁ and α₂ are the weightings of the cost value of S₁₁ and radiation pattern.

### B. Optimized Results

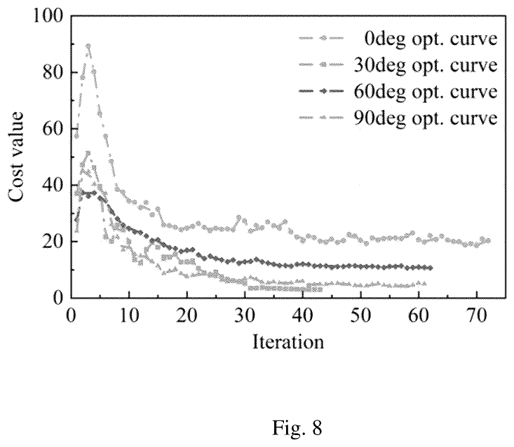

The iteration of optimizing is recorded in FIG. 8. Among the synthesized antennas, the 0-deg broadside antenna takes the most computational time to converge. This is due to the physical limitations. The feeding coaxial probe radiates in an omnidirectional manner like a monopole antenna. However, the direction of the feeding peak radiation changes from the x-y plane to an angle elevated from that plane. Consequently, the optimization for the 0-degree broadside antenna is particularly challenging as it is difficult to regulate the radiation towards the broadside direction. The NMSE values of S₁₁ and radiation pattern outputs for 4 antennas are mostly below 0.1. Additionally, the Pearson correlation values are close to 1, indicating a strong correlation between the predicted and simulated values. These results demonstrate that the Het-GCN model is effective and yields promising outcomes. Although the NMSE for the 90-degree antenna is slightly higher, suggesting a larger difference between the predicted and simulated values, the high correlation still indicates a reliable trend match.

The utilization of the Het-GCN model significantly enhances the efficiency of the optimization process. With the assistance of the Het-GCN model, each optimization round takes approximately 2 minutes. In contrast, performing the same optimization without the assistance of an AI model would require thousands of minutes. These results are provided in Table III. The efficiency enables more extensive exploration and trial iterations, reducing the risk of getting trapped in a local minimum during optimization and increasing the likelihood of finding the global minimum solution.

TABLE III
THE MODEL PERFORMANCE ON THE OPTIMIZING
RESULT COMPARE WITH THE SOLID SIMULATION

| | | | | | | | Time | |
|---|---|---|---|---|---|---|---|---|
| | Expected | | | | | | taken | Time taken |
| | main | S₁₁ (3.5 | | | | | using | using |
| | beam | GHz-10.5 GHz) | | RP (5.8 GHz) | | Iterations | Het- | HFSS |
| Antenna | direction | NMSE | [symbol] | NMSE | [symbol] | required | GCN | (estimated) |
| Ant. I | 0° | 0.0046 | 0.9802 | 0.0346 | 0.9897 | 73 | 2.85 | 5840 mins. |
| | | | | | | | mins. | |
| Ant. II | 30° | 0.0064 | 0.9930 | 0.0023 | 0.9989 | 43 | 1.40 | 3440 mins. |
| | | | | | | | mins. | |
| Ant. III | 60° | 0.0280 | 0.9544 | 0.0474 | 0.9490 | 64 | 2.36 | 5120 mins. |
| | | | | | | | mins. | |
| Ant. IV | 90° | 0.0992 | 0.9990 | 0.0585 | 0.9864 | 66 | 1.83 | 5280 mins. |
| | | | | | | | mins. | |

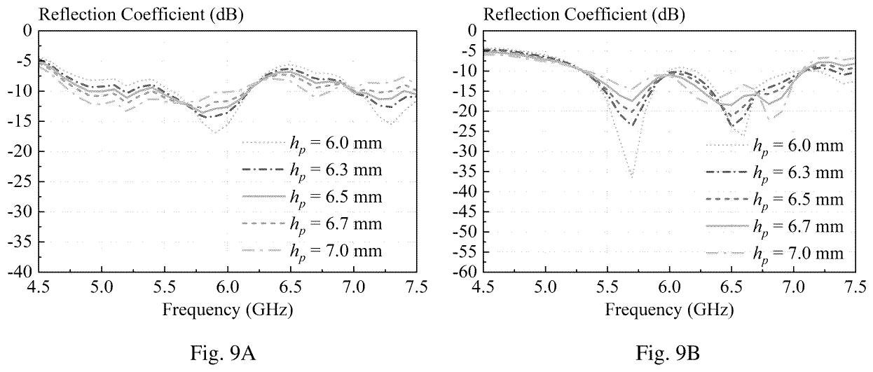

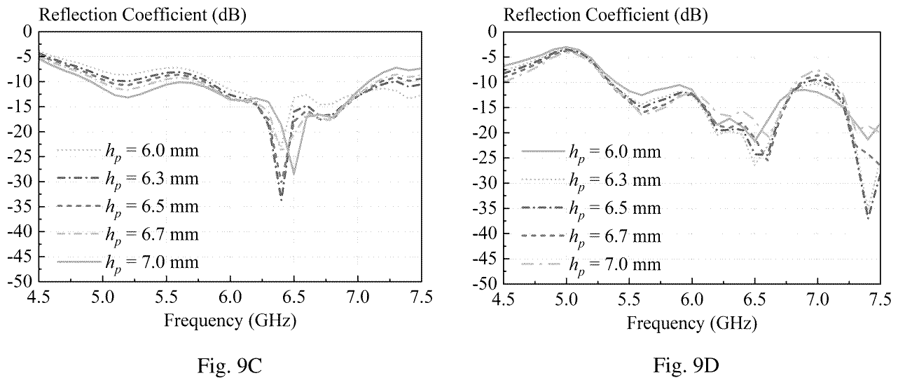

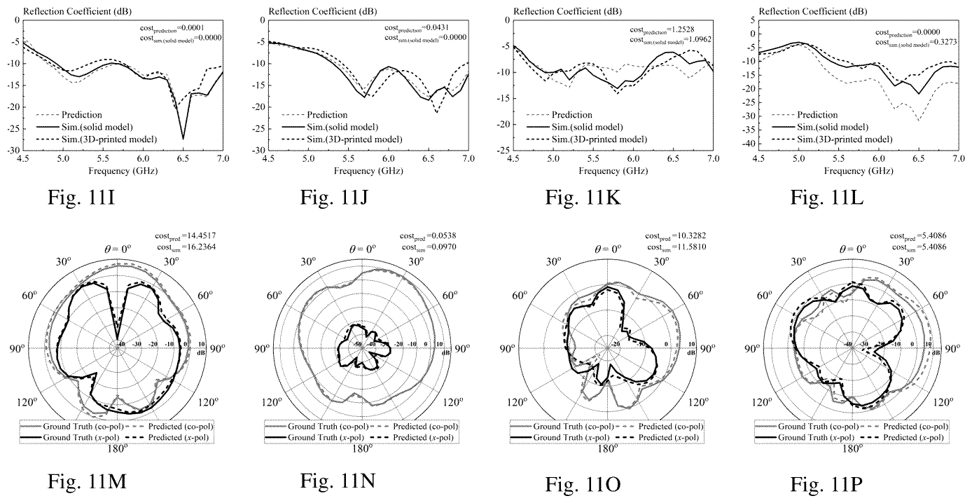

FIGS. 11A-11P provide the optimization and simulation results of the four antennas. The dielectric constant distributions (ε_{eff}) of the four antennas are shown in FIGS. 11A-11D. From these figures, it is evident that the asymmetrical and irregular permittivity distribution patterns are quite challenging to adjust manually. The probe heights for the four antennas are optimized to 7 mm, 6.7 mm, 6.5 mm and 6.0 mm, respectively. The width of rings w_{d} (or the ring radius ΔR) is fixed at 5 mm for all d for 0-deg, 30-deg and 60-deg antennas. Then the total radius of the three antennas is 35 mm. However, for the 90-deg antenna, w_{d,90deg} of the 7 rings is optimized as [0 mm, 0 mm, 0 mm, 6 mm, 6 mm, 12 mm, 13 mm] respectively, with a total radius of 37 mm. The variation in the ring radius demonstrates the higher generalizability of the graph data compared to sequential data or Euclidean data. The corresponding Sn results of the design variable hₚ for the four antennas are studied in FIGS. 9A-9D. The proposed optimized method ensures the largest bandwidth of the reflection coefficient.

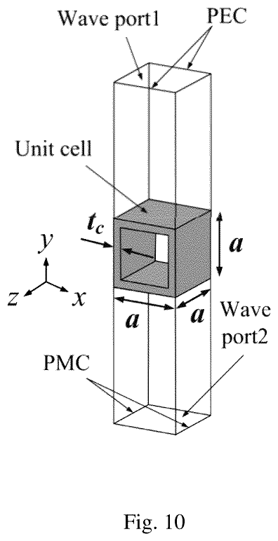

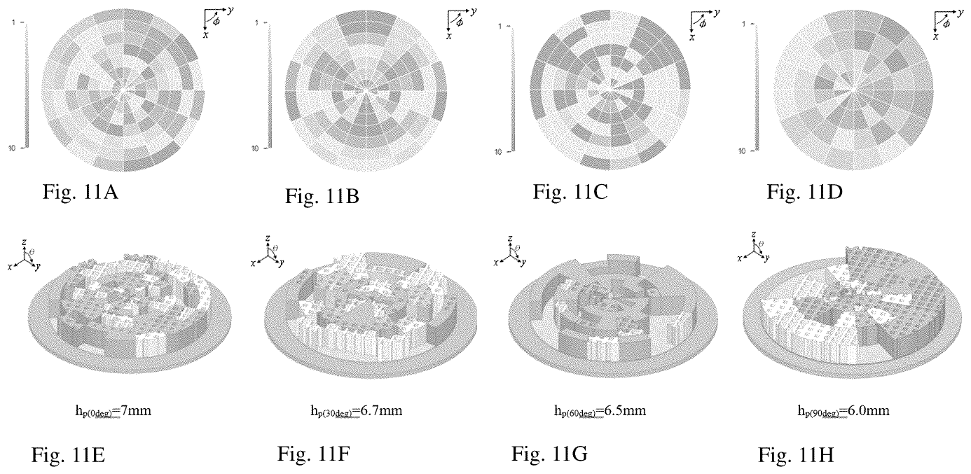

During fabrication, the effective dielectric constants can be realized using the cube unit cell proposed in [37], as FIG. 10 depicts. According to the effective 3D-printing model as shown in FIG. 10, the optimized antenna can be modelled into the 3D-printing structure. As the wall thickness the changes, the effective dielectric constant of each unit can be realized from 0-10. By varying the ratio of wall thickness t_{c} and side length a of each dielectric unit block, effective permittivity is regulated. With a fixed side length a of 4 mm, the relationship between t_{c} and ε_{eff} is described as follows:

$${ε}_{eff} = 0.55 {t}_{c} {ε}_{r} - 0.04 {ε}_{r} + 1.3 \qquad ( 1 )$$

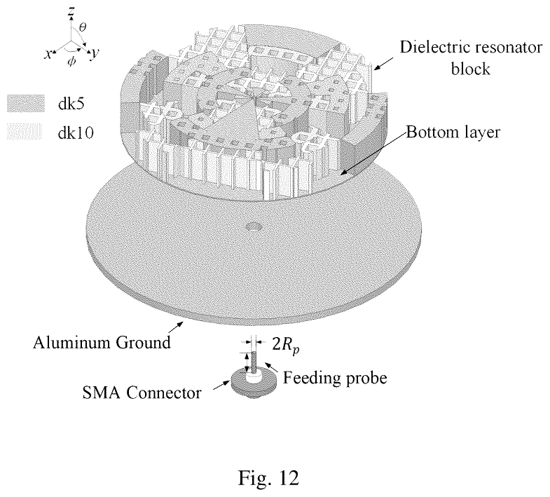

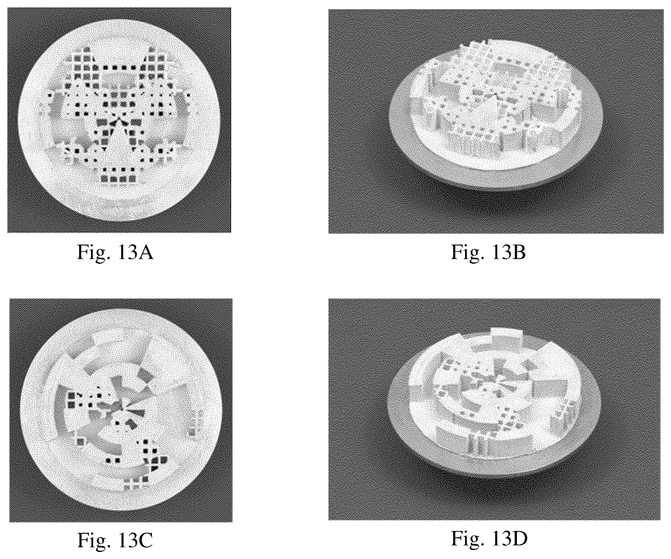

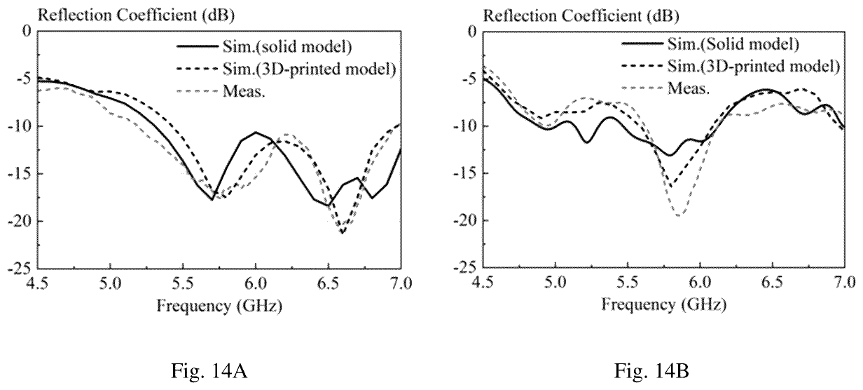

To realize different effective permittivity values, two materials with εᵣ=5 and εᵣ=10 are utilized in the 3D-printing model. The wall thickness t_{c} of the cube unit is calculated for each ε_{effv} as stated in Table IV. The 3D-printing models are then constructed based on the corresponding solid models, as depicted in FIG. 11E-11H. The use of material with εᵣ=5 helps avoid the risk of having too thin walls. As an example, the final structure of the 30-deg 3D-printing antenna to be fabricated is illustrated in FIG. 12.

TABLE IV
THE EFFECTIVE PERMITTIVITY AND
CORRESPONDING WALL THICKNESS

| | a | | | | | | |
|---|---|---|---|---|---|---|---|
| | 4 | | | | | | |
| | εᵣ | | | | | | |
| | 1 (air) | 5 | | 10 | | | |
| ε_{eff} | 1 | 2.5 | 4 | 5.5 | 7 | 8.5 | 10 |
| t_{c} | 0 | 0.51 | 1.05 | 0.84 | 1.11 | 1.38 | 2 |

The simulated S₁₁ (including the solid model and 3D-printing model) and predicted S₁₁ can be found in FIGS. 11I-11L. The electromagnetic characteristics of the optimized antenna remain stable after being transformed into the 3D-printing models. The radiation patterns on the x-z plane are presented in FIGS. 11M-11P. According to the visualized data, the prediction outputs from the Het-GCN model align well with the simulation results. The main radiation beams of each antenna are clearly visible. The optimized results meet predefined requirements. However, the cross-polarization pattern of the 0-deg antenna is slightly inferior due to the physical constraints discussed earlier. The slight shift in the main-beam direction is acceptable, as the RP prediction precision of the Het-GCN is 10°. However, affected by the aluminum ground, the maximum gain of the 90-deg antenna that ought to occur at 90° now occurs at 70° in the simulation. Despite this, the entire simulated pattern agrees well with the predicted one. The 0-deg, 30-deg, 60-deg and 90-deg antennas demonstrate simulated peak gains of 5.88 dBi, 10.13 dBi, 7.49 dBi, and 5.58 dBi, respectively. These peak gains indicate the maximum concentration of radiation in the desired directions for each specific antenna.

### C. Fabrication and Measurement

The 30-deg and 60-deg antenna prototypes are fabricated as proof-of-concept. FIGS. 13A-13D show the top view and perspective view of the fabrication prototype, i.e., top view and perspective view of fabricated 30-deg antenna in FIGS. 13A and 13B, and top view and perspective view of 60-deg antenna in FIGS. 13C and 13D.

The 3D-printed structure of both antennas has a height of 9 mm and a radius of 35 mm. To ensure easy alignment and detachment of the printed DRA from the building platform, a thin dielectric layer measuring 0.3 mm in thickness and 35 mm in radius was printed underneath the DRA. The 3D printer used in this scenario offers a fabrication tolerance of 0.1 mm and a resolution of 0.05 mm. It takes approximately 5 hours to complete one antenna printing with an overall expense of materials below $50 USD.

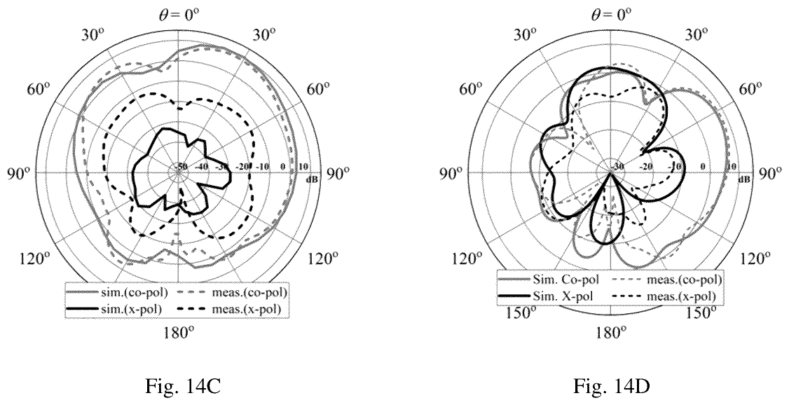

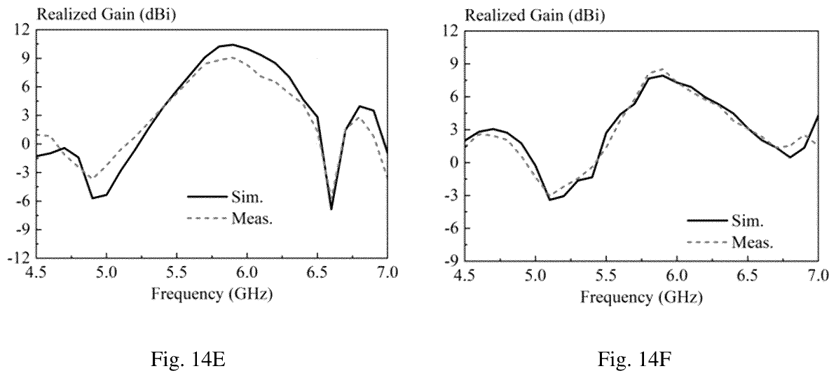

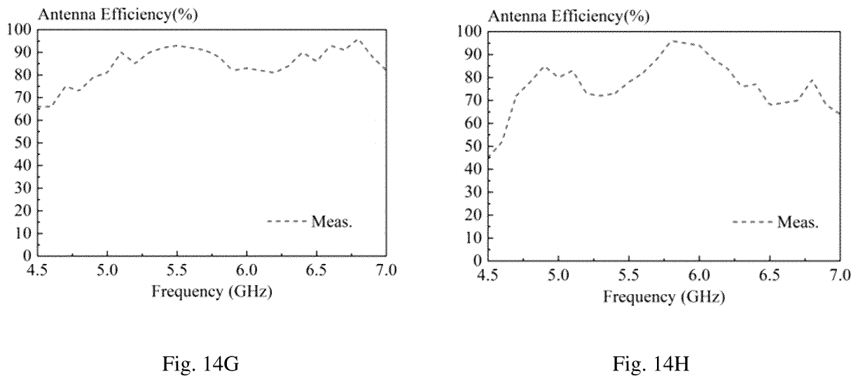

The measurement results are compared with the simulation in FIGS. 14A-14H. Reflection coefficient performance of solid model simulation, 3D-printing simulation and measurement of the 30-deg and 60-deg antennas are given in FIGS. 14A and 14B. Referring to the figures, the measured Su agrees well with the simulation of the 3D-printing antenna model. The minor difference is caused by the experimental tolerances.

The simulated and measured radiation patterns of the 3D-printing model are shown in FIGS. 14C and 14D. FIGS. 14C and 14D show measurement results of radiation pattern of the x-z plane at 5.8 GHz of the fabricated 30-deg antenna and 60-deg antenna, respectively. The figures clearly indicate that the measured co-polar field is stronger than its cross-polar counterpart more than 20 dB. FIGS. 14E and 14F show measurement results of realized gain at the maximum radiating direction of the fabricated 30-deg antenna and 60-deg antenna, respectively. The measured gain of 30-deg is 8.8 dBi at 5.8 GHz, and that of the 60-deg antenna achieves 8.14 dBi. The efficiencies of both antennas remain approximately at 90% within the expected band at 5.8 GHz, as depicted in FIGS. 14G and 14H. Overall, although there is some discrepancy between simulated and measured results, the general agreement is reasonable.

### V. Conclusions

This disclosure investigates synthesizing four cylindrical antennas using a robust graph convolution network, Het-GCN. The Het-GCN can be used for forward simulating and inverse auto-design. It helps in the synthesis of antennas with specific performance requirements, such as radiation in desired directions. Compared to other AI models, the critical advantage of Het-GCN lies in its ability to capture more interaction information within an antenna structure. Therefore, it is proven to be more accurate. The Het-GCN achieves a minimum NMSE loss of 0.06022 and the highest Pearson correlation of 0.95308. The flexible topology structure of Het-GCN enables more flexible antenna designs. This also provides a possibility for further transfer learning on other similar types of antennas. This AI model can effectively reduce simulation time while maintaining reasonable accuracy, particularly when multiple similar antennas are required. With the help of the Het-GCN model, four directional antennas radiating in the upper half elevation plane are efficiently generated. These antennas are divided into 7×16 dielectric resonator blocks. The directional radiation is accomplished by adjusting the effective dielectric constant distribution within these blocks. The complex-shaped DRA fabrication is accomplished using 3-D printing techniques. Despite some deviations between the simulated results and the measured results, the overall performance agrees well.

### Example Features and Modifications of Some Embodiments

Some embodiments of the invention present four antennas that radiate in four different directions based on a robust graph convolution network, Het-GCN. The model can be used for forward simulating and inverse auto-design, synthesizing antennas with desired performance, i.e., radiation directions. Compared with other ML models, the critical advantage of this model is that it captures more interaction information inside an antenna structure.

In some embodiments, the configuration of the cylindrical DRA can have other numbers of dielectric resonator blocks,

In some embodiments, the effective dielectric constant can be other formulas.

In some embodiments, the dielectric constant and thickness of the used material can be changed to other values.

In some embodiments, the radiating directions of the cylinder DRA can be other values.

In some embodiments, the operating frequency can be changed to other frequency bands.

### Example Functions and Applications of Some Embodiments

Some embodiments of the invention can realize the high-gain beam with specific radiating direction in almost upper half space flexibly for tricky angle of communication. Thus, the antennas designed according to some embodiments of the invention can be used in radars and various wireless communications.

### Example Advantages of Some Embodiments

Compared to the existing designs, the directional dielectric resonator antennas designed or synthesized using the deep graph learning model according to some embodiments of the invention are more efficient with a high gain at the desired frequency band.

According to some embodiments of the invention, the design flexibility is significantly increased with the help of graph learning, and it is able to achieve the radiation at the whole upper elevation half-plane with the same basic configuration.

Compared to the existing design methods based on artificial intelligence, the design methods according to some embodiments of the invention have higher accuracy and generalizability.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features. Some embodiments of the invention may lack one or more of these optional features.

### REFERENCES

All referenced literatures throughout this disclosure are incorporated herein by reference in their entirety, which include the following references:
[1] M. I. Jordan and T. M. Mitchell, “Machine learning: Trends perspectives and prospects,” Science, vol. 349, no. 6245, pp. 255-260, July 2015.
[2] S. D. Campbell, R. P. Jenkins, P. J. O'Connor and D. Werner, “The explosion of artificial intelligence in antennas and propagation: How deep learning is advancing our state of the art,” IEEE Antennas Propag. Mag., vol. 63, no. 3, pp. 16-27, October 2020
[3] M. A. Hearst, S. T. Dumais, E. Osuna, J. Platt and B. Scholkopf, “Support vector machines,” in IEEE Intelligent Systems and their Applications, vol. 13, no. 4, pp. 18-28, July-August 1998, doi: 10.1109/5254.708428.
[4] P. Baldi, “Autoencoders unsupervised learning and deep architectures,” in Proc. 2011 Int. Conf. Unsupervised Transfer Learning Workshop, vol. 27, pp. 37-50, 2011.
[5] H. Ramchoun, “Multilayer perceptron: Architecture optimization and training,” Int. J. Interactive Multimedia Artif. Intell., vol. 4, no. 1, pp. 26-30, 2016.
[6] Y. LeCun, Y. Bengio and G. Hinton, “Deep learning,” Nature, vol. 521, no. 7553, pp. 436-444, May 2015.
[7] I. Goodfellow et al., “Generative adversarial networks,” Communications of the ACM, vol. 63, no. 11, pp. 139-144, 2020.
[8] A. Cleeremans, D. Servan-Schreiber, and J. L. McClelland, “Finite state automata and simple recurrent networks,” Neural Comput., vol. 1, no. 3, pp. 372-381, September 1989.
[9] A. Krizhevsky, I. Sutskever, and G. E. Hinton, “ImageNet classification with deep convolutional neural networks,” Communications of the ACM, vol. 60, no. 6, pp. 84-90, May 2017.
[10] F. Zhuang et al., “A Comprehensive Survey on Transfer Learning,” in Proceedings of the IEEE, vol. 109, no. 1, pp. 43-76, January 2021.
[11] I. Sajedian, T. Badloe, and J. Rho, “Optimisation of colour generation from dielectric nanostructures using reinforcement learning,” Opt. Express, vol. 27, no. 4, pp. 5874-5883 February 2019.
[12] G. Godi, R. Sauleau, L. L. Coq and D. Thouroude, “Design and Optimization of Three-Dimensional Integrated Lens Antennas With Genetic Algorithm,” in IEEE Transactions on Antennas and Propagation, vol. 55, no. 3, pp. 770-775, March 2007.
[13] J. Wu, A. H. Abdelrahman, M. Liang, X. Yu and H. Xin, “Monopole Antenna Radiation Pattern Control via 3D Printed Dielectrics,” IEEE Transactions on Antennas and Propagation, vol. 65, no. 8, August 2017.
[14] Y. Sharma, X. Chen, J. Wu, Q. Zhou, H. H. Zhang and H. Xin, “Machine Learning Methods-Based Modeling and Optimization of 3-D-Printed Dielectrics Around Monopole Antenna,” in IEEE Transactions on Antennas and Propagation, vol. 70, no. 7, pp. 4997-56 July 2022, doi: 10.1109/TAP.2022.3153688.
[15] A. Zhou and Q. Zhang, “A surrogate-assisted evolutionary algorithm for minimax optimization,” in IEEE Congress on Evolutionary Computation, 2010: IEEE, pp. 1-7.
[16] K. Fu, X. Cai, B. Yuan, Y. Yang and X. Yao, “An Efficient Surrogate Assisted Particle Swarm Optimization for Antenna Synthesis,” in IEEE Transactions on Antennas and Propagation, vol. 70, no. 7, pp. 4977-4984 July 2022, doi: 10.1109/TAP.2022.3153080.
[17] S. Koziel and S. Ogurtsov, “Antenna design by simulation-driven optimization,” in Surrogate-Based Approach, New York, Springer, 2014.
[18] J. Tak, A. Kantemur, Y. Sharma and et al., “A 3-D-printed W-band slotted waveguide array antenna optimized using machine learning,” IEEE Antennas and Wireless Propagation Letters, vol. 17, no. 11, pp. 2008-2012, 2018.
[19] S. Koziel, N. Calik, P. Mahouti, and M. A. Belen, “Accurate Modeling of Antenna Structures by Means of Domain Confinement and Pyramidal Deep Neural Networks,” IEEE Transactions on Antennas and Propagation, vol. 70, no. 3, pp. 2174-2188, 2022, doi: 10.1109/tap.2021.3111299.
[20] D. R. Prado, J. A. López-Fernández, M. Arrebola and G. Goussetis, “Support Vector Regression to Accelerate Design and Crosspolar Optimization of Shaped-Beam Reflectarray Antennas for Space Applications,” in IEEE Transactions on Antennas and Propagation, vol. 67, no. 3, pp. 1659-1668 March 2019, doi: 10.1109/TAP.2018.2889029.
[21] W. T. Li, H. S. Tang, C. Cui, Y. Q. Hei, and X. W. Shi, “Efficient Online Data-Driven Enhanced-XGBoost Method for Antenna Optimization,” IEEE Transactions on Antennas and Propagation, vol. 70, no. 7, pp. 4953-4964, 2022, doi: 10.1109/tap.2022.3157895.
[22] S. Koziel, A. Bekasiewicz, I. Couckuyt and T. Dhaene, “Efficient multi-objective simulation-driven antenna design using co-kriging,” IEEE Trans. Antennas Propag., vol. 62, no. 11, pp. 5900-595 November 2014.
[23] S. Mishra, R. N. Yadav and R. P. Singh, “Directivity estimations for short dipole antenna arrays using radial basis function neural networks,” IEEE Antennas Wireless Propag. Lett., vol. 14, pp. 1219-1222 February 2015.
[24] L. Y. Xiao, W. Shao, F. L. Jin, B. Z. Wang, and Q. H. Liu, “Inverse Artificial Neural Network for Multiobjective Antenna Design,” IEEE Transactions on Antennas and Propagation, vol. 69, no. 10, pp. 6651-6659, 2021, doi: 10.1109/tap.2021.3069543.
[25] L. Yuan, X. S. Yang, C. Wang, and B. Z. Wang, “Multibranch Artificial Neural Network Modeling for Inverse Estimation of Antenna Array Directivity,” IEEE Transactions on Antennas and Propagation, vol. 68, no. 6, pp. 4417-4427, 2020, doi: 10.1109/tap.2020.2970071.
[26] H. M. Yao and L. J. Jiang, “Machine Learning Based Neural Network Solving Methods for the FDTD Method,” 2018 IEEE International Symposium on Antennas and Propagation & USNC/URSI National Radio Science Meeting, 2018, pp. 2321-2322.
[27] A. Sperduti and A. Starita, “Supervised neural networks for the classification of structures,” IEEE Trans. Neural Netw., vol. 8, no. 3, pp. 714-735, May 1997.
[28] M. Gori, G. Monfardini, and F. Scarselli, “A new model for learning in graph domains,” in Proc. IEEE Int. Joint Conf. Neural Netw., vol. 2, August 2005, pp. 729-734.
[29] F. Scarselli, M. Gori, A. C. Tsoi, M. Hagenbuchner, and G. Monfardini, “The graph neural network model,” IEEE Trans. Neural Netw., vol. 20, no. 1, pp. 61-80, January 2009.
[30] C. Gallicchio and A. Micheli, “Graph echo state networks,” in Proc. Int. Joint Conf. Neural Netw. (IJCNN), July 2010, pp. 1-8.
[31] S. Zhang, H. Tong, J. Xu, and R. Maciejewski, “Graph convolutional networks: a comprehensive review,” Comput. Soc. Netw., vol. 6, no. 1, p. 11, December 2019, doi: 10.1186/s40649-019-0069-y.
[32] Ragesh, Rahul, et al. “HeteGCN: Heterogeneous graph convolutional networks for text classification.” Proceedings of the 14th ACM International Conference on Web Search and Data Mining. 2021.
[33] Shui, Zeren, and George Karypis. “Heterogeneous molecular graph neural networks for predicting molecule properties.” 2020 IEEE International Conference on Data Mining (ICDM). IEEE, 2020.
[34] P. B. Jørgensen, K. W. Jacobsen, and M. N. Schmidt, “Neural message passing with edge updates for predicting properties of molecules and materials,” arXiv preprint arXiv: 1806.03146, 2018.
[35] Zhang, Guo, Hao He, and Dina Katabi. “Circuit-GNN: Graph neural networks for distributed circuit design.” International conference on machine learning. PMLR, 2019.
[36] S. Long, M. McAllister, and L. Shen, “The resonant cylindrical dielectric cavity antenna,” IEEE Transactions on Antennas and Propagation, vol. 31, no. 3, pp. 406-412, May 1983, doi: 10.1109/TAP.1983.1143080.
[37] Z. X. Xia, K. W. Leung and K. Lu, “3-D-Printed Wideband Multi-Ring Dielectric Resonator Antenna,” in IEEE Antennas and Wireless Propagation Letters, vol. 18, no. 10, pp. 2110-2114 October 2019, doi: 10.1109/LAWP.2019.2938009.
[38] L. Guo, K. W. Leung and Y. M. Pan, “Compact Unidirectional Ring Dielectric Resonator Antennas With Lateral Radiation,” in IEEE Transactions on Antennas and Propagation, vol. 63, no. 12, pp. 5334-5342 December 2015, doi: 10.1109/TAP.2015.2493579.
[39] M. Welling and T. N. Kipf, “Semi-supervised classification with graph convolutional networks,” in J. International Conference on Learning Representations (ICLR 2017), 2016.
[40] Y. Ding, X. Zhao, Z. Zhang, W. Cai and N. Yang, “Graph Sample and Aggregate-Attention Network for Hyperspectral Image Classification,” in IEEE Geoscience and Remote Sensing Letters, vol. 19, pp. 1-5, 2022, Art no. 5504205, doi: 10.1109/LGRS.2021.3062944.
[41] M. Schlichtkrull. T. N. Kipf. P. Bloem. R. v. d. Berg. I. Titov, and M. Welling. “Modeling relational data with graph convolutional networks.” in European semantic web conference. 2018: Springer. pp. 593-607.

1. A computer-implemented method of training a heterogeneous graph convolution network (Het-GCN) for antenna design, comprising:
modeling an antenna as graph data, the graph data comprising heterogeneous graphs representing different components of the antenna;
generating radiation pattern and reflection coefficient of the antenna for a dataset based on the graph data; and
training the Het-GCN using the dataset.

2. The computer-implemented method of claim 1, wherein the antenna comprises a cylindrical dielectric resonator antenna (DRA) which includes:
a ground plane;
a dielectric resonator element operably coupled with the ground plane; and
a feeding probe operably coupled with the dielectric resonator element.

3. The computer-implemented method of claim 2, wherein the ground plane comprises an Aluminium ground, and the dielectric resonator element comprises a first number (N) of layers of different dielectric constants arranged from the feeding probe, and is angularly divided into a second number (M) of sections such that the dielectric resonator element consists of N×M dielectric resonator blocks.

4. The computer-implemented method of claim 3, wherein the cylindrical DRA is centrally fed by the feeding probe with a height of hₚ.

5. The computer-implemented method of claim 4, wherein antenna characteristics of the cylindrical DRA are adjusted by manipulating dielectric constant distribution within the dielectric resonator blocks, the height (hₚ) of the feeding probe, and a width (w_{d}) of a layer of the dielectric resonator element.

6. The computer-implemented method of claim 3, wherein modeling the antenna as graph data further comprises randomly generating antenna parameters, the antenna parameters comprising dielectric constant distribution, a height (hₚ) of the feeding probe, and a width (w_{d}) of a layer of the dielectric resonator element.

7. The computer-implemented method of claim 1, wherein the graph data comprises node attributes for the components of the cylindrical DRA where each component serves as a node, and edge attributes for interactions between nodes.

8. The computer-implemented method of claim 7, wherein the components of the cylindrical DRA comprise the dielectric resonator blocks and the feeding probe.

9. The computer-implemented method of claim 8, wherein the node attributes are constructed based geometric parameters and material property of the components of the cylindrical DRA.

10. The computer-implemented method of claim 7, wherein the interactions between nodes comprise propagations of electromagnetic wave between adjacent nodes.

11. The computer-implemented method of claim 1, wherein the Het-GCN is designed to perform convolution function on the graph data.

12. The computer-implemented method of claim 11, wherein in the Het-GCN, different types of relations are assigned by specified convolution functions, and weights are not shared among the different types of relations.

13. The computer-implemented method of claim 12, wherein in the Het-GCN, a readout function is operated on all node features in a convoluted graph to obtain a graph-level representation (GLR).

14. The computer-implemented method of claim 13, wherein the Het-GCN is structured with two separate branches of multi-layer perceptions (MLPs) operated on the graph-level representation for predicting the radiation pattern and the reflection coefficient respectively.

15. A computer-implemented method of designing a cylindrical dielectric resonator antenna (DRA) using the Het-GCN as trained by the method of claim 1, comprising:
obtaining a desired antenna structure of the cylindrical DRA with a specific radiating direction using the trained Het-GCN.

16. The computer-implemented method of claim 15, wherein obtaining the desired antenna structure comprises:
providing radiation pattern and reflection coefficient of a reference antenna structure to the trained Het-GCN;
initializing randomly in the neighborhood of the reference antenna structure; and
iteratively obtaining an optimal antenna structure using mini-batch gradient descent.

17. The computer-implemented method of claim 16, wherein iteratively obtaining the optimal antenna structure comprises adjusting dielectric constant distribution within the dielectric resonator blocks for controlling radiation pattern variation and the height of the feeding probe for impedance matching.

18. The computer-implemented method of claim 17, wherein iteratively obtaining the optimal antenna structure further comprises adjusting the width of the layer of the dielectric resonator element.

19. The computer-implemented method of claim 15, wherein the specific radiating direction is one of four different elevation angles, 0°, 30°, 60° and 90°.

20. A system for training a heterogeneous graph convolution network (Het-GCN) for antenna design, comprising:
one or more processors; and
memory storing one or more programs configured to be executed by the one or more processors, the one or more programs including instructions for performing or facilitating performing of the method of claim 1.

21. A system for designing a cylindrical dielectric resonator antenna (DRA) using a heterogeneous graph convolution network (Het-GCN), comprising:
one or more processors; and
memory storing one or more programs configured to be executed by the one or more processors, the one or more programs including instructions for performing or facilitating performing of the method of claim 15.

22. A non-transitory computer-readable storage medium storing one or more programs configured to be executed by one or more processors, the one or more programs including instructions for performing or facilitating performing of the method of claim 1.

23. A non-transitory computer-readable storage medium storing one or more programs configured to be executed by one or more processors, the one or more programs including instructions for performing or facilitating performing of the method of claim 15.
